(19) United States
(12) Patent Application Publication
(10) Pub. No.: US 2019/0011601 A1
(43) Pub. Date: Jan. 10, 2019

(54) PANEL FOR INCREASING TRANSMITTANCE OF CAMERA LENS AND MANUFACTURING METHOD THEREOF

(71) Applicants: Interface Technology (ChengDu) Co., Ltd., Chengdu (CN); Interface Optoelectronics (ShenZhen) Co., Ltd., Shenzhen (CN); General Interface Solution Limited, Miaoli County (TW)

(72) Inventor: Jing-Bing YU, Miaoli County (TW)

(21) Appl. No.: 15/676,074

(22) Filed: Aug. 14, 2017

(30) Foreign Application Priority Data
Jul. 5, 2017 (CN) 201710541297.6

(51) Int. Cl. G02B 1/11; G03B 17/56

(52) U.S. Cl. CPC G02B 1/11; G03B 17/565

(57) ABSTRACT

A panel for increasing transmittance of a camera lens comprises a substrate, a shielding layer and an anti-reflective coating structure. The substrate comprises a panel region and a peripheral region. The peripheral region surrounds the panel region. The shielding layer is located on the peripheral region. The shielding layer has a camera lens. The camera lens is a window for capturing images. The anti-reflective coating structure comprises an optical adhesive layer, an anti-reflective coating base material layer and an anti-reflective coating layer. The optical adhesive layer is located on the substrate and inside the camera lens. A manufacturing method of a panel is provided for increasing transmittance of camera lens. The anti-reflective coating structure adheres to the camera lens via the optical adhesive layer, so as to increase the production efficiency and to reduce the cost.

### CROSS-REFERENCE TO RELATED APPLICATION

This application claims priority of application No. 201710541297.6, filed on Jul. 5, 2017 in the State Intellectual Property Office of the People's Republic of China, the content thereof is incorporated by reference herein.

### FIELD OF THE INVENTION

The present invention relates to a panel and a manufacturing method thereof for increasing transmittance of a camera lens, and more particularly, to a panel and a manufacturing method that provides an anti-reflective coating structure on the camera lens via an optical adhesive layer, so as to increase the production efficiency and to reduce costs.

### BACKGROUND OF THE INVENTION

A camera lens is a standard component of an electronic device such as a mobile phone, a tablet computer and a notebook computer. To achieve increased imaging quality without altering the camera module, the transmittance of the protecting panel is improved so as to decrease the optical loss when capturing an image. According to the conventional products, the largest transmission coefficient of the protecting panel is 92% at a 550 nanometer wavelength without any processing. To increase the transmission coefficient, the prior art plates multilayer optical film on the inner surface (camera aperture region) of the protecting panel. The name of the multilayer optical film layer is an anti-reflective coating layer.

Taiwan patent I544385 discloses a touch panel, having a substrate, a shielding layer and a first anti-reflection layer. The shielding layer is located on the surface of the substrate and has a camera lens. The surface of the substrate is defined by hollowing out a part of the shielding layer. The first anti-reflection layer is located inside the camera lens.

However, the patent described above plates the optical film layer on glass by means of vacuum coating, which requires a specialized jig and limits the production efficiency. Unfortunately the vacuum furnace occupies more space due to an increased size of the vacuum furnace resulting in a reduced economic benefit. Since the drawback of low production efficiency and high cost, the conventional method is only applied to high-end products due to cost considerations.

Therefore there is immediate need for an improved panel and manufacturing method that increases production efficiency and reduces cost.

### SUMMARY OF THE INVENTION

An objective of the present invention is to provide a panel and a manufacturing method for increasing transmittance of a camera lens which features high production efficiency and reduced cost of the equipment.

In order to achieve the above and other objectives, the present invention provides a panel for increasing transmittance of a camera lens, which comprises a substrate, a shielding layer and an anti-reflective coating structure.

The substrate comprises a panel region and a peripheral region. The peripheral region surrounds the panel region.

The shielding layer is located on the peripheral region and comprises a camera lens. The camera lens is a window for capturing images.

The anti-reflective coating structure comprises an optical adhesive layer, an anti-reflective coating base material layer and an anti-reflective coating layer.

The optical adhesive layer is located on the substrate and inside the camera lens. The optical adhesive layer extends to the surface of the shielding layer surface with a height.

The anti-reflective coating base material layer is located on the optical adhesive layer. The anti-reflective coating layer is on the anti-reflective coating base material layer.

The anti-reflective coating structure adheres to but separated from the camera lens via the optical adhesive layer.

In order to achieve these objectives and more, the present invention provides an improved manufacturing method of a panel for increasing transmittance of camera lens.

The manufacturing method begins by supplying a substrate, a shielding layer and an anti-reflective coating structure, the substrate comprising a panel region and a peripheral region, the peripheral region surrounding the panel region, the shielding layer having a camera lens, the anti-reflective coating structure comprising an optical adhesive layer, an anti-reflective coating base material layer and an anti-reflective coating layer.

The method continues by disposing the shielding layer on the peripheral region and then disposing the anti-reflective coating structure on the camera lens and adhering the optical adhesive layer to the substrate.

Through the above described panel and method, the present invention applies the anti-reflective coating structure on the camera lens via the optical adhesive layer, so as to increase the production efficiency and to reduce the cost.

### BRIEF DESCRIPTION OF THE DRAWINGS

FIG. 1 is a schematic view of a panel for increasing transmittance of camera lens according to an embodiment of the present invention;

FIG. 2 is a side view of a panel for increasing transmittance of camera lens according to an embodiment of the present invention;

FIG. 3 is a flowchart of a manufacturing method of a panel for increasing transmittance of camera lens according to an embodiment of the present invention;

FIG. 4 is a flowchart of another embodiment of a manufacturing method of a panel for increasing transmittance of camera lens according to an embodiment of the present invention; and

FIG. 5 is a schematic view of relationship between transmittance and transmission light wavelength of a panel for increasing transmittance of camera lens according to an embodiment of the present invention compared to a transparent glass without film.

### DETAILED DESCRIPTION OF THE EMBODIMENTS

A preferred embodiment of the present invention is illustrated by drawings and described below to enable persons skilled in the art to gain insight into the present invention.

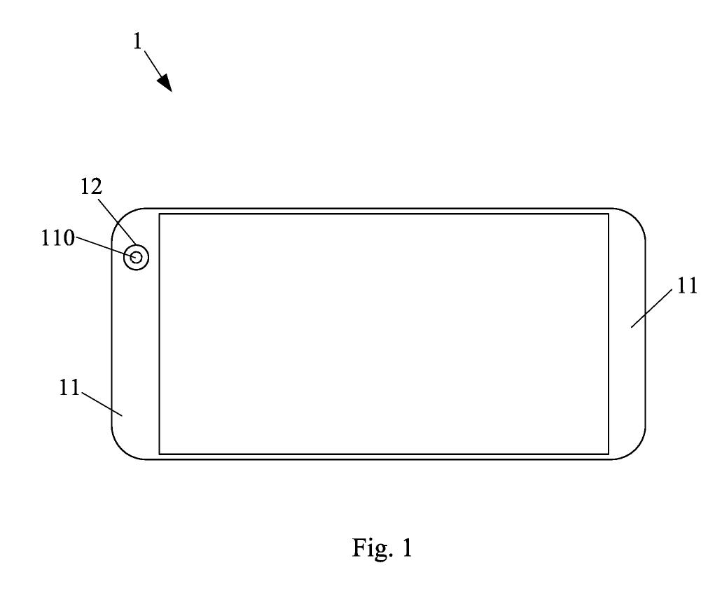

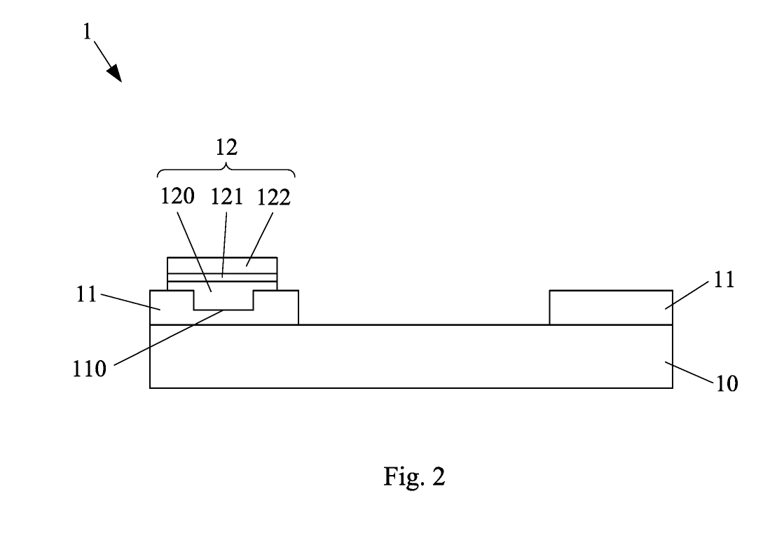

Referring to FIGS. 1 and 2, a panel for increasing transmittance of camera lens (1) of the present invention comprises a substrate (10), a shielding layer (11) and an anti-reflective coating structure (12).

The substrate (10) comprises a panel region (100) and a peripheral region (101). The peripheral region (101) surrounds the panel region (100).

The shielding layer (11) is located on the peripheral region (101). The shielding layer (101) has a camera lens (110). The camera lens (110) is a window for capturing images.

The anti-reflective coating structure (12) comprises an optical adhesive layer (120), an anti-reflective coating base material layer (121) and an anti-reflective coating layer (122).

The optical adhesive layer (120) is located on the substrate (10) and inside the camera lens (110). The optical adhesive layer (120) extends to the surface of the shielding layer (11) surface with a height.

The anti-reflective coating base material layer (121) is located on the optical adhesive layer (120) for increasing the transmittance of the camera lens (110). The anti-reflective coating layer (122) is on the anti-reflective coating base material layer (121) for increasing the transmittance of the camera lens (110).

The anti-reflective coating structure (12) adheres to but separated from the camera lens (110) via the optical adhesive layer (120).

In an embodiment of the present invention, each of the shapes of the optical adhesive layer (120), the anti-reflective coating base material layer (121) and the anti-reflective coating layer (122) is circular in shape.

In an embodiment of the present invention, each of the diameters of the optical adhesive layer (120), the anti-reflective coating base material layer (121) and the anti-reflective coating layer (122) is greater than the diameter of the camera lens within 1 millimeter to 5 millimeters.

In an embodiment of the present invention, the diameter range of the camera lens (110) is 1 millimeter to 10 millimeters.

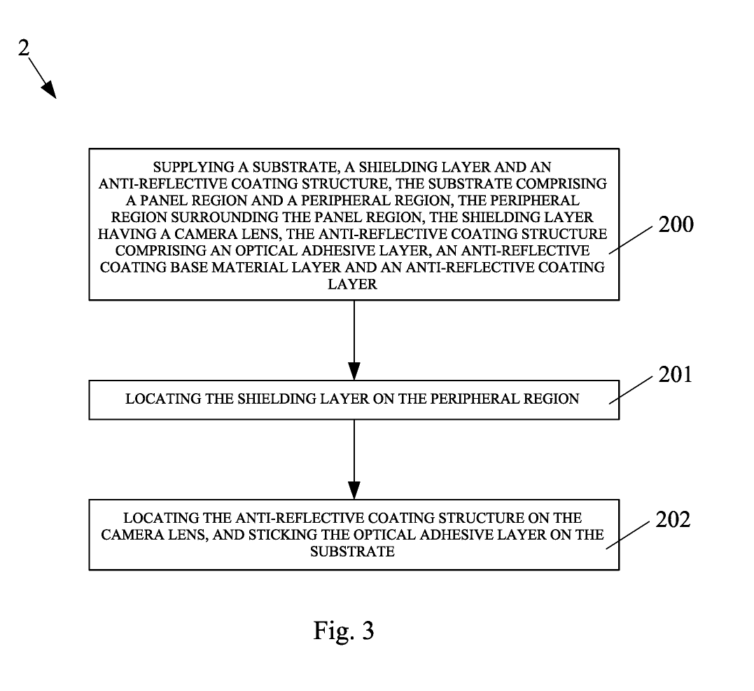

Referring to FIG. 1, FIG. 2 and FIG. 3, a manufacturing method of a panel for increasing transmittance of camera lens (2) of the present invention comprises the following steps:

step 200: supplying a substrate (10), a shielding layer (11) and an anti-reflective coating structure (12), the substrate (10) comprising a panel region (100) and a peripheral region (101), the peripheral region (101) surrounding the panel region (100), the shielding layer (11) having a camera lens (110), the anti-reflective coating structure (12) comprising an optical adhesive layer (120), an anti-reflective coating base material layer (121) and an anti-reflective coating layer (122);

step 201: locating the shielding layer (11) on the peripheral region (101);

step 202: locating the anti-reflective coating structure (12) on the camera lens (110), and sticking the optical adhesive layer (120) on the substrate (10).

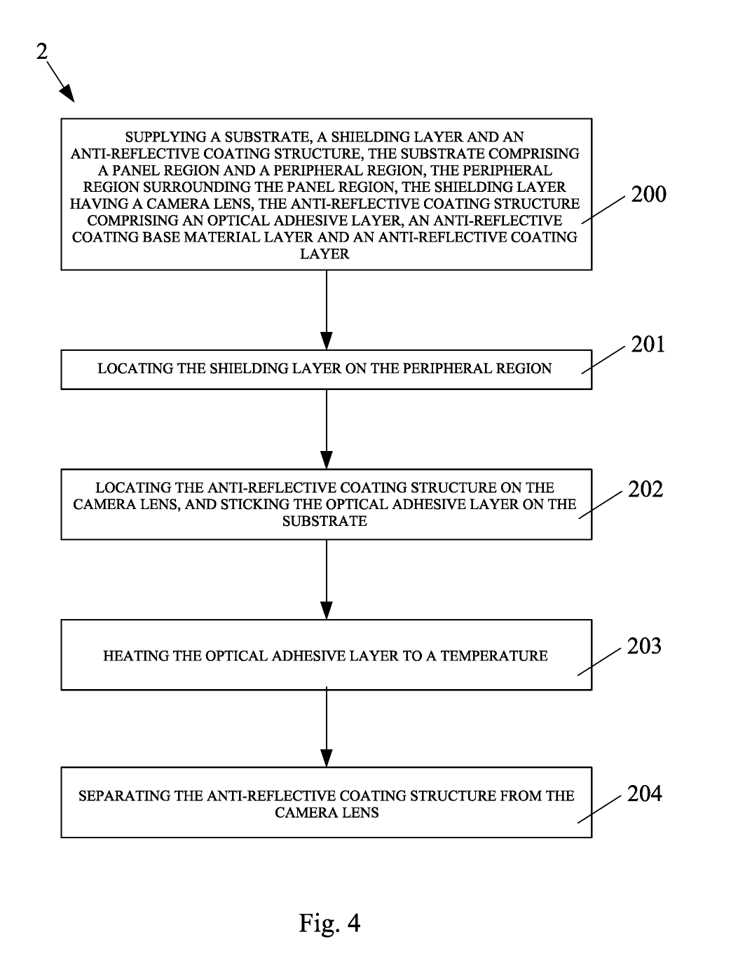

Referring to FIG. 1, FIG. 2 and FIG. 4, in a preferred embodiment of the present invention, the manufacturing method of a panel for increasing transmittance of camera lens (2) further comprises the following steps after step 202:

step 203: heating the optical adhesive layer (120) to a temperature;

step 204: separating the anti-reflective coating structure (12) from the camera lens (110).

Wherein in step 203, since the stickiness of the optical adhesive layer (120) is lower when the optical adhesive layer (120) is heated, the anti-reflective coating structure (12) is easily separated from the camera lens (110) by an increased temperature to the optical adhesive layer (120). If the anti-reflective coating structure (12) had not aligned to the camera lens (110), through steps 203 and 204, the anti-reflective coating structure (12) can be easily removed for realigning the anti-reflective coating structure (12) with the camera lens (110). As a result the present invention allows reworking and provides high production efficiency.

In an embodiment of the present invention, each of the shapes of the optical adhesive layer (120), the anti-reflective coating base material layer (121) and the anti-reflective coating layer (122) is a circular shape.

In an embodiment of the present invention, each of the diameters of the optical adhesive layer (120), the anti-reflective coating base material layer (121) and the anti-reflective coating layer (122) is greater than the diameter of the camera lens (110) within 1 millimeter to 5 millimeters.

In an embodiment of the present invention the diameter range of the camera lens (110) is 1 millimeter to 10 millimeters.

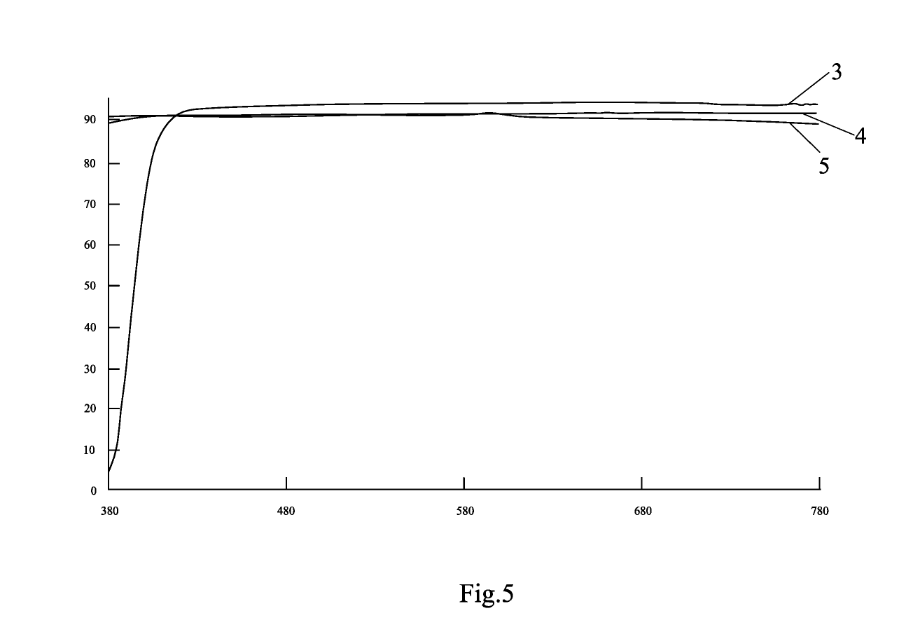

Refer to FIG. 1, FIG. 2 and FIG. 5. FIG. 5 is a schematic view of the relationship between transmittance and transmission light wavelength of the panel for increasing transmittance of camera lens (1) according to an embodiment of the present invention compared with a first transparent glass without film and a second transparent glass without film. Wherein the Y axis represents transmittance and the X axis represents transmission light wavelength. In FIG. 5, a curved line 3 represents a relationship between transmittance and transmission light wavelength of the panel for increasing transmittance of camera lens (1) according to the present invention. A curved line 4 represents a relationship between transmittance and transmission light wavelength of the first transparent glass without film. A curved line 5 represents a relationship between transmittance and transmission light wavelength of the second transparent glass without film. When compared to the first transparent glass without film and the second transparent glass without film, the panel for increasing transmittance of camera lens (1) according to the present invention increases transmittance dramatically.

The prior art plates the anti-reflective coating layer on the camera lens by vacuum coating. In contrast to the prior art, the present invention adheres the anti-reflective coating structure (12) on the camera lens (110) via the optical adhesive layer (120), which not only increases transmittance of camera lens, but also simplifies production and decreases costs while providing a panel with the same optical class at a lower price.

The above detailed description fully shows that the objectives and advantages of the present invention are non-obvious, have high industrial applicability, and shows that the present invention is novel. Therefore, the present invention meets patentability requirements. The present invention is disclosed above by preferred embodiments. However, persons skilled in the art should understand that the preferred embodiments are illustrative of the present invention only, but should not be interpreted as restrictive of the scope of the present invention. Hence, all equivalent changes and modifications to the aforesaid embodiments should fall within the scope of the present invention. Accordingly, the legal protection for the present invention should be defined by the appended claims.

What is claimed is:

1. A panel for increasing transmittance of a camera lens, comprising:
a substrate comprising a panel region and a peripheral region, the peripheral region surrounding the panel region;
a shielding layer being located on the peripheral region, the shielding layer having a camera lens, the camera lens being a window for capturing images;
an anti-reflective coating structure comprising:
an optical adhesive layer disposed on the substrate and inside the camera lens, the optical adhesive layer extending to the surface of the shielding layer surface with a height;
an anti-reflective coating base material layer disposed on the optical adhesive layer; and
an anti-reflective coating layer disposed on the anti-reflective coating base material layer;
wherein the anti-reflective coating structure adheres to the camera lens via the optical adhesive layer and the anti-reflective coating structure is separated from the camera lens by the optical adhesive layer.

2. The panel for increasing transmittance of a camera lens according to claim 1, wherein the optical adhesive layer, the anti-reflective coating base material layer and the anti-reflective coating layer are circular in shape.

3. The panel for increasing transmittance of a camera lens according to claim 2, wherein diameters of the optical adhesive layer, the anti-reflective coating base material layer and the anti-reflective coating layer are greater than the diameter of the camera lens within 1 millimeter to 5 millimeters.

4. The panel for increasing transmittance of a camera lens according to claim 1, wherein the diameter range of the camera lens is 1 millimeter to 10 millimeters.

5. The panel for increasing transmittance of a camera lens according to claim 2, wherein the diameter range of the camera lens is 1 millimeter to 10 millimeters.

6. The panel for increasing transmittance of a camera lens according to claim 3, wherein the diameter range of the camera lens is 1 millimeter to 10 millimeters.

7. A manufacturing method of a panel for increasing transmittance of a camera lens, comprising:
supplying a substrate, a shielding layer and an anti-reflective coating structure, the substrate comprising a panel region and a peripheral region, the peripheral region surrounding the panel region, the shielding layer having a camera lens, the anti-reflective coating structure comprising an optical adhesive layer, an anti-reflective coating base material layer and an anti-reflective coating layer;
disposing the shielding layer on the peripheral region; and
disposing the anti-reflective coating structure on the camera lens, and adhering the optical adhesive layer to the substrate.

8. The manufacturing method of a panel for increasing transmittance of a camera lens according to claim 7, further comprising:
heating the optical adhesive layer to a temperature; and
separating the anti-reflective coating structure from the camera lens.

9. The manufacturing method of a panel for increasing transmittance of a camera lens according to claim 7, wherein the optical adhesive layer, the anti-reflective coating base material layer and the anti-reflective coating layer are circular in shape.

10. The manufacturing method of a panel for increasing transmittance of a camera lens according to claim 9, wherein the diameters of the optical adhesive layer, the anti-reflective coating base material layer and the anti-reflective coating layer are greater than the diameter of the camera lens within 1 millimeter to 5 millimeters.

11. The manufacturing method of a panel for increasing transmittance of a camera lens according to claim 7, wherein the diameter range of the camera lens is 1 millimeter to 10 millimeters.

12. The manufacturing method of a panel for increasing transmittance of a camera lens according to claim 8, wherein the diameter range of the camera lens is 1 millimeter to 10 millimeters.

13. The manufacturing method of a panel for increasing transmittance of a camera lens according to claim 9, wherein the diameter range of the camera lens is 1 millimeter to 10 millimeters.

14. The manufacturing method of a panel for increasing transmittance of a camera lens according to claim 10, wherein the diameter range of the camera lens is 1 millimeter to 10 millimeters.
